(19) United States
(12) Patent Application Publication
(10) Pub. No.: US 2011/0149264 A1
(43) Pub. Date: Jun. 23, 2011

(54) Electrical Connection System, Lithographic Projection Apparatus, Device Manufacturing Method and Method for Manufacturing an Electrical Connection System

(75) Inventor: Johannes Wilhelmus Damen, Budel (NL)

(73) Assignee: ASML Netherlands B.V., Veldhoven (NL)

(21) Appl. No.: 12/823,569

(22) Filed: Jun. 25, 2010

Related U.S. Application Data
(60) Provisional application No. 61/220,695, filed on Jun. 26, 2009.

(51) Int. Cl. H01R 13/40; G03B 27/58; H01R 9/05; H01R 43/00

(52) U.S. Cl. 355/72; 439/625; 439/578; 439/586; 29/857

(57) ABSTRACT

An electrical connection system is disclosed. The electrical connection system comprises a housing, an elongate conductor and a flexible planar electrical connector. The housing comprises a front plate having a conducting surface and a back plate having a conducting surface. The elongate conductor extends through the front plate. The flexible planar electrical connector comprises a laminate that comprises, in order, a first flexible planar insulating layer, a conductor configured to carry an electrical current and a second flexible planar insulating layer. The flexible planar electrical connector is sandwiched by and extends beyond the front plate and the back plate. The elongate conductor is electrically connected to the conductor of the planar connector.

### CROSS REFERENCE TO RELATED APPLICATION

This application claims priority under 35 U.S.C. §119(e) to U.S. Provisional Patent Application No. 61/220,695, filed Jun. 26, 2009, which is incorporated by reference herein in its entirety.

### FIELD

The present invention relates to an electrical connection system, a lithographic apparatus, a method for manufacturing a device and a method for manufacturing an electrical connection system.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., comprising part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

Some moving parts of the lithography apparatus are powered by a high voltage power supply. Furthermore, for some lithographic processes, parts of the lithography apparatus are kept at very low pressure. In particular, at very low pressure, a high voltage power supply may be used to power any actuators, blades or clamps that may be part of the lithography apparatus. Actuators are used to position the table on which the substrate is placed. Actuators also power blades that block a portion of the projection beam. Clamps hold the mask or the substrate to a table. One example of a clamp is an electrostatic clamp, which comprises electrodes that are connected to a power supply.

Due to the fact that high voltage is used, and in particular because the components are situated in a very low-pressure environment, there is a problem that electrical breakdown may occur. The possibility of electrical breakdown limits the voltage of the power lines and presents a safety hazard. If a breakdown occurs, it can damage optical surfaces, create electromagnetic interference that disturbs sensitive electronics and present a human safety hazard.

### SUMMARY

It is desirable, for example, to provide an electrical connection system suitable for making a high voltage electrical connection at low pressure in which electrical breakdown is reduced or eliminated.

According to an aspect of the present invention, there is provided an electrical connection system. The electrical connection system comprises a housing, an elongate conductor, a flexible planar electrical connector and a bushing. The housing comprises a front plate having a conducting surface. The elongate conductor extends through the front plate. The flexible planar electrical connector comprises a conductor. The bushing electrically insulates the elongate conductor from the conducting surface of the front plate. The elongate conductor is electrically connected to the conductor of the planar connector.

According to a further aspect of the present invention, there is provided an electrical connection system. The electrical connection system comprises a housing, an elongate conductor and a flexible planar electrical connector. The housing comprises a front plate having a conducting surface and a back plate having a conducting surface. The elongate conductor extends through the front plate. The flexible planar electrical connector comprises a laminate that comprises, in order, a first flexible planar insulating layer, a conductor configured to carry an electrical current and a second flexible planar insulating layer. The flexible planar electrical connector is sandwiched by and extends beyond the front plate and the back plate. The elongate conductor is electrically connected to the conductor of the planar connector.

According to a further aspect of the present invention, there is provided a method for manufacturing an electrical connection system configured to connect an elongate conductor to a flexible planar electrical connector. The method comprises the steps of:

attaching a bushing to a terminus of the elongate conductor;

inserting the terminus with the attached bushing into a hole that extends through a front plate having a conducting surface such that the bushing electrically insulates the elongate conductor from the a conducting surface of the front plate; and

electrically connecting the terminus to a conductor comprised in the planar connector.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a schematic view of one embodiment of the invention;

FIG. 3 depicts a schematic view of a flexible planar electrical connector according to one embodiment of the invention;

FIG. 4 depicts a graph of a theoretical Paschen curve for parallel plates in air, the graph having a x-axis of gap distance in meters and a y-axis of breakdown voltage in volts;

FIG. 5 depicts a beam interceptor connected to a power supply by a connection system according to an embodiment of the invention;

FIG. 6 depicts an electrostatic clamp connected to a power supply by a connection system according to an embodiment of the invention;

FIG. 7 depicts an electrostatic clamp connected to a flexible planar electrical connector according to an embodiment of the invention;

FIG. 8 depicts a schematic view of an embodiment of the invention; and

FIG. 9 depicts a schematic view of an embodiment of the invention.

### DETAILED DESCRIPTION

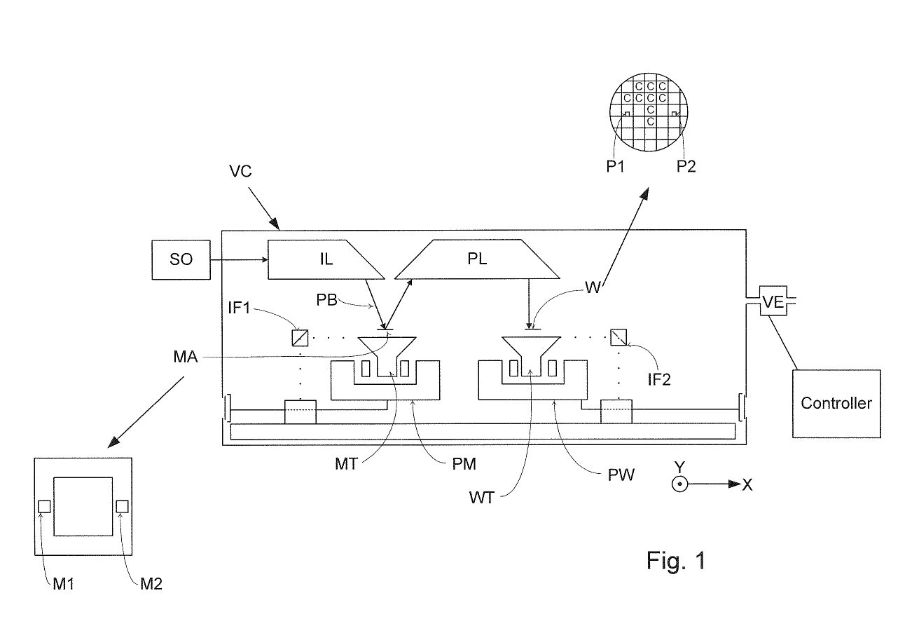

FIG. 1 schematically depicts a lithographic apparatus according to one embodiment of the invention. The apparatus comprises:

an illumination system (illuminator) IL configured to condition a radiation beam B (e.g., UV radiation or EUV radiation);

a support structure (e.g., a mask table) MT constructed to support a patterning device (e.g., a mask) MA and connected to a first positioner PM configured to accurately position the patterning device in accordance with certain parameters;

a substrate table (e.g., a wafer table) WT constructed to hold a substrate (e.g., a resist-coated wafer) W and connected to a second positioner PW configured to accurately position the substrate in accordance with certain parameters; and

a projection system (e.g., a refractive projection lens system) PS configured to project a pattern imparted to the radiation beam B by patterning device MA onto a target portion C (e.g., comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e., bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is-reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a reflective type (e.g., employing a reflective mask). Alternatively, the apparatus may be of a transmissive type (e.g., employing a transmissive mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

A masking device, which defines the area on the patterning means that is illuminated, may be included in the illuminator IL. The masking device may comprise a plurality of blades, for example four, whose positions are controllable, e.g., by actuators such as stepper motors, so that the cross-section of the beam may be defined. It should be noted that the masking device need not be positioned proximate the patterning means but in general will be located in a plane that is imaged onto the patterning means (a conjugate plane of the patterning means). The open area of the masking means defines the area on the patterning means that is illuminated but may not be exactly the same as that area, e.g., if the intervening optics have a magnification different than 1.

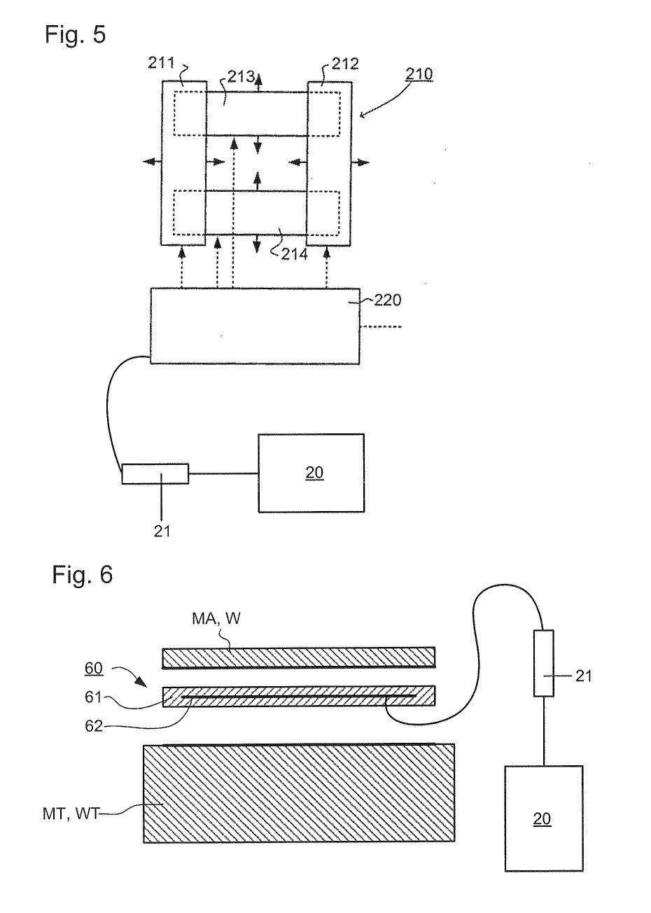

According to an embodiment of the invention, the masking device comprises a beam interceptor 210, comprising opaque blades 211, 212, 213, 214 that are arranged to intercept part of the radiation beam B, as is shown in FIG. 5. The blades 211, 212, 213, 214 manipulate the size and shape of the exposed projection beam B on the mask MA and accordingly on the target portions C. The movement and positioning of the blades 211, 212, 213, 214 is controlled by a control system 220. If a projected target portion C is not fully positioned on the substrate W, the control system 220 is arranged to define a new size for this particular target portion C and actuate the beam interceptor 210 accordingly.

The patterning device (e.g., mask MA) is held on the support structure (e.g., mask table MT) and is patterned by the patterning device. The mask MA can be clamped to the mask table MT on both surfaces of the mask. By clamping the mask MA on both surfaces, the mask can be subjected to large accelerations without slipping or deformation. The clamping, or holding force may be applied using thin membranes, which further prevent deformation of the mask. By the clamp, a normal force between adjacent surfaces of the mask and the mask table MT is generated, resulting in a friction between contacting surfaces of the mask and the mask table. The clamping force to the surfaces of the mask MA may be generated using electrostatic or mechanical clamping techniques.

In lithographic processes, electrostatic clamps may be used to clamp the mask MA to the mask table MT and/or the substrate W to the substrate table WT. FIG. 6 depicts an exemplary electrostatic clamp that is connected to a power supply 20 via an electrical connection system 21 according to an embodiment of the present invention. In the exemplary electrostatic clamp depicted in FIG. 6, a chuck 60 comprises a dielectric or slightly conductive body 61 with an embedded electrode 62. The power supply 20 is used to apply a potential difference between the mask MA or the substrate W and the chuck 60 and between the chuck 60 and the table MT, WT so that electrostatic forces clamp the mask MA or substrate W and the chuck 60 to the table MT, WT. The embedded electrode 62 is connected to the power supply 20.

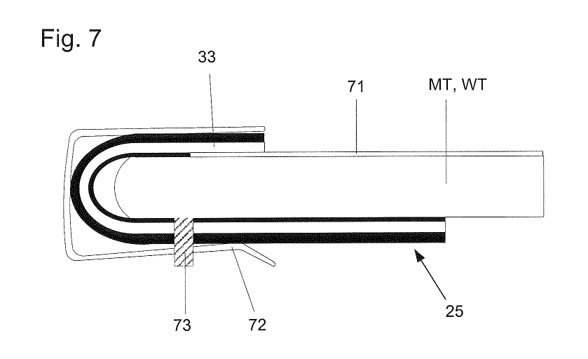

FIG. 7 schematically depicts how a flexible planar electrical connector 25 that comprises part of an electrical connection system 21 according to an embodiment of the invention may be connected to an electrode 71 of a mask table MT or a substrate table WT. The conductor 33 of the flexible electrical connector 25 contacts the electrode 71. The flexible connector 25 is held to the electrode 71 by a clip 72. The clip is flexible and provides a force pressing the connector 25 to the table. This provides a secure electrical connection between the flexible connector 25 and the electrode 71.

Optionally, the electrical connector 25 is held to the electrode 71 by a combination of a clip 72 and a pin 73. The pin 73 is connected to the clip 72 and extends through a hole in the electrical connector 25 to contact the table on which the electrode 71 is formed.

The radiation beam B is incident on the patterning device (e.g., mask MA). Having traversed the mask MA, the radiation beam B passes through the projection system PS, which focuses the beam onto a target portion C of the substrate W. With the aid of the second positioner PW and position sensor IF2 (e.g., an interferometric device, linear encoder or capacitive sensor), the substrate table WT can be moved accurately, e.g., so as to position different target portions C in the path of the radiation beam B. Similarly, the first positioner PM and another position sensor IF1 can be used to accurately position the mask MA with respect to the path of the radiation beam B, e.g., after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e., a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

The first positioner PM, the second positioner PW, the motors that control any blades that may be comprised in the masking device and any clamps that may be comprised in the lithographic projection apparatus are powered by a high voltage power supply. In particular, the electrodes of an electrostatic clamp used for clamping a substrate W to a substrate table WT or a mask M to a mask table MT in near-vacuum conditions are connected to a bi-polar high voltage supply.

High voltage is taken to mean that the power supply produces an output of the order of hundreds or thousands of volts. In an embodiment, the output of the power supply is greater than 0.1 kV, greater than 0.2 kV, greater than 0.5 kV, greater than 1 kV, greater than 2 kV, greater than 5 kV, or greater than 10 kV.

Some lithographic manufacturing methods are required to be performed at very low pressure, such as 100 Pa, 50 Pa, 10 Pa or 5 Pa. For example, lithographic methods that use EUV radiation must be performed at a very low pressure. This is because air absorbs the EUV radiation. Each component of the lithographic apparatus must therefore be suitable for use at low pressure. This includes the electrical connectors that connect one or more components of the lithographic apparatus to high voltage power supplies.

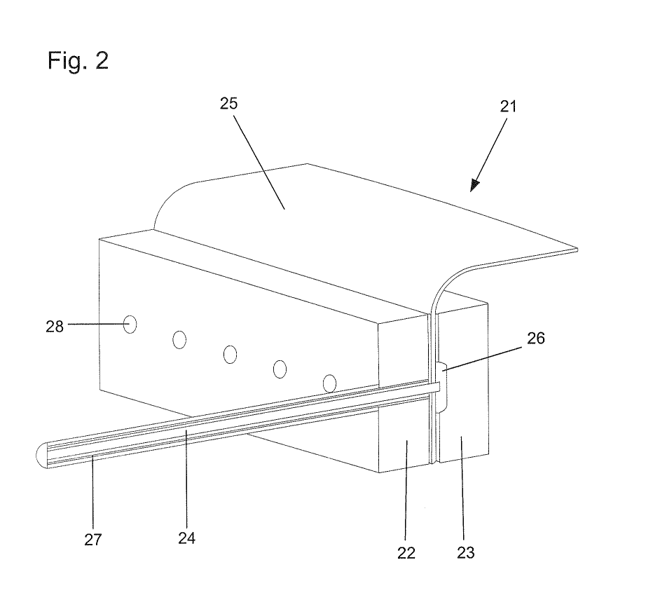

FIG. 2 schematically depicts an electrical connection system according to one embodiment of the present invention. The electrical connection system 21 connects an elongate conductor 24 to a flexible planar electrical connector 25.

The electrical connection system 21 comprises a housing, an elongate conductor 24 and a flexible planar electrical connector 25. The elongate conductor 24 is electrically connected to the planar connector 25. The housing comprises two plates, a front plate 22 and a back plate 23. The planar connector 25 is sandwiched by the plates 22, 23. The planar connector 25 extends beyond the plates 22, 23. As such, part of the external planar surfaces of the planar connector 25 is exposed to the environment of the connection system 21. The planar connector 25 and the elongate conductor 24 may be electrically connected to other electrical connectors or electronic devices. In particular, the electrical connection system 21 may be connected to a high voltage power supply.

The plates of the housing may be made of an electrically conducting material. Alternatively, the plates of the housing may be made of an electrically insulating material, but have an electrically conducting surface. For example, the plates may be made of a plastic and be plated with an electrically conducting material. The plates may be die cast. Desirably the plates are corrosion resistant. Preferably, the surface of the plates 22, 23 that contacts the planar connector 25 is flat. As discussed below, the plates 22, 23 are electrically grounded.

The purpose of the housing is to control the electric field produced by the elongate conductor 24 and the flexible planar electrical connector 25. For many lithographic applications in which an elongate conductor 24 and a flexible planar electrical connector 25 are used, the voltage of the conductors is very high, e.g., hundreds or thousands of volts. Unless the electric field is controlled, suppressed or blocked, there is a danger that arcing occurs from the elongate conductor 24 or planar electrical connector 25 to another component of the lithographic apparatus.

The housing controls the electric field by capturing free electrons from the electrical connectors 24, 25 before they acquire dangerous levels of kinetic energy, and/or by preventing electrons from accelerating in dangerous directions through the gas in the environment of the connection system. As such, it is desirable for the plates 22, 23 that have an electrically conductive surface to be electrically connected to ground potential. Therefore, optionally, the front plate 22 and/or the back plate 23 have a connecting region on the outer surface configured to connect to ground potential.

Hence, the housing according to an embodiment of the present invention performs a different function to the housing of conventional electrical connection systems. For example, some conventional electrical connection systems have a housing that is made of an insulating material, such as an insulating plastic. This provides mechanical protection for the connection. Although such a connection system may be suitable for use at low voltages, it may fail in applications requiring high voltage electrical lines to be connected due to arcing from the electrical line to other electrically conductive components.

In a standard electrical connector for connecting shielded conductors, the outer housing of the connector is required to form a grounded screen that totally surrounds the shielded conductor at the connection point. The purpose of this is to confine the electric field to the space between the shielded conductor and the housing. The only break in the housing may be venting holes that are small enough not to significantly disturb the electric field.

The electrical connection system according to an embodiment of the present invention works by a different principle, which does not require the housing to form an uninterrupted grounded screen around the electrical lines that are connected.

The front plate 22 comprises a hole 28 through which the elongate conductor 24 extends. The front plate 22 and the back plate 23 are arranged such that the flexible planar electrical connector 25 is positioned between the two plates. Within the connection system, the elongate conductor 24 is electrically connected to the planar connector 25. A thickness of the plates 22, 23 is, for example, between about 5 mm and 10 mm.

Optionally, the elongate conductor 24 extends through the flexible planar electrical connector 25. It must be ensured that the elongate conductor 24 does not come into electrical contact with the back plate 23. This is because there may be a large potential difference between the elongate conductor 24 and the back plate 23 and electrical discharge would lower the voltage of the elongate conductor. Therefore, the back plate 23 optionally comprises a depression 26 adjacent a section of the flexible planar electrical connector 25 that is electrically connected to the elongate conductor 24.

In electrical connectors that are used to connect electrical lines, in addition to the danger of arcing between one of the electrical lines and another electrical component of the lithographic apparatus, there is the further danger of arcing between one electrical line and another piece of conductive material within the connection system. A sufficient minimum distance between an electrical line within the electrical connection system 21 and another piece of conductive material within the connection system 21 may be provided. The minimum distance may depend on the voltage of the electrical line. Additionally or alternatively, a maximum distance may be provided.

In the electrical connection system of the present invention, the distance between an end of the elongate conductor 24 and a surface of the back plate 23 may be set to be below a threshold distance, for example 3 mm. This reduces or avoids electrical breakdown when the electrical connection system 21 is used in a low-pressure environment.

Setting an upper limit for gap distances at extremely low pressure prevents electrical breakdown because the relationship between breakdown voltage and gap distance is different at low pressure compared to atmospheric pressure. Specifically, at atmospheric pressure, as the gap distance is reduced, the breakdown voltage is reduced accordingly. When the pressure is sufficiently low however, the breakdown voltage dramatically increases as the gap distance is decreased below a threshold distance. The graphical form of the relationship between gap distance (x-axis) and breakdown voltage (y-axis) at a pressure of 10 Pa is depicted in FIG. 4.

Under pressure conditions that are sufficiently low, electrical breakdown is more likely to occur along a longer gap between electrical conductors than a short path. This means that provided that the distance between electrical conductors within an electrical connector is sufficiently small and the pressure is sufficiently low, the breakdown voltage will be too high for electrical breakdown to occur.

In fact, the theoretical breakdown voltage is related to the product of gap distance and pressure by the formula:

$$V = \frac{Apd}{ln ( pd ) + B} .$$

The values of the constants A and B depend on the composition of the gas, in which the conductors are situated, and the material and geometry of the conductors. For parallel plates in air, A≈450 VPa⁻¹m⁻¹ and B≈1.5, where V is measured in Volts, p is measured in Pascals and d is measured in metres. As mentioned above, although this formula may be used to predict the theoretical electrical breakdown voltage between conductors, the actual electrical breakdown voltage in a given situation may be differ from the value determined by this formula.

The minimum value of V occurs at

$$d = \frac{{e}^{1 - B}}{p} .$$

To the right of this turning point in the curve (the “elbow”), breakdown voltage is seen to behave in a well-known manner, increasing together with both increasing gap distance and pressure. To the left of the elbow, the breakdown voltage dramatically increases as either the gap distance or pressure is lowered. Therefore, electrical discharge can be reduced or avoided by ensuring that the product pd is left of the elbow.

The flexible planar electrical connector comprises a laminate that comprises, in order, a first flexible planar insulating layer, a conductor 33 configured to carry an electrical current and a second flexible planar insulating layer. The elongate conductor is electrically connected to the conductor 33.

The first insulating layer and the second insulating layer must be sufficient to prevent electrical breakdown between the conductor 33 and the housing. Optionally, the insulating material of the insulating layers has a dielectric strength greater than 40 kVmm⁻¹, greater than 60 kVmm⁻¹, greater than 80 kVmm⁻¹, or greater than 100 kVmm⁻¹. The insulating material may be selected from a group consisting of a polyimide, a liquid crystal polymer and a glass. Optionally, the first insulating layer and the second insulating layer are made of poly(4,4′-oxydiphenylene-pyromellitimide).

It is desirable that the insulating layers are thin in order to improve the flexibility of the planar electrical connector 25. Optionally, a thickness of the insulating layers is less than 0.3 mm, less than 0.2 mm, less than 0.15 mm, less than 0.1 mm, or less than 0.05 mm.

Optionally, the electrical connector is sandwiched by a first planar conducting layer and a second planar conducting layer. The conducting layers may be made of copper. The second conducting layer comprises a signal portion 31 that is electrically connected to the conductor 33 of the planar connector and a shield portion 32 that surrounds and is electrically isolated from the signal portion 31. In this case, the elongate conductor is electrically connected to the signal portion 31 of the second conducting layer.

Optionally, a minimum distance between the signal portion 31 and the shield portion 32 is at least 0.5 mm, at least 1 mm, at least 1.5 mm, or at least 2 mm. Optionally, a minimum distance between the signal portion 31 and the shield portion 32 is at most 3 mm. The shield portion 32 is isolated from the signal portion 31 by an insulator 34.

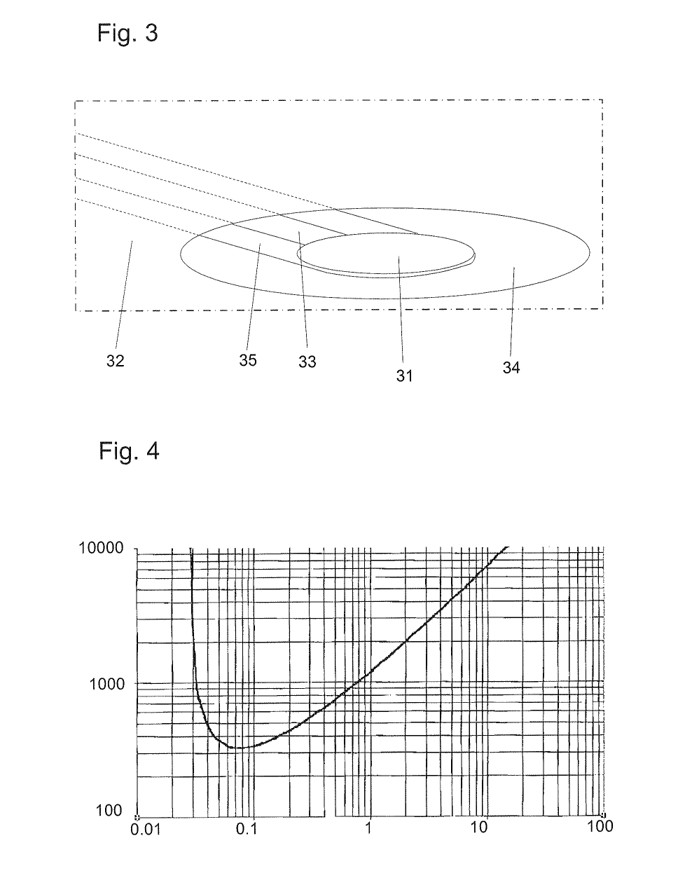

FIG. 3 schematically depicts a surface of the flexible electrical connector 21 from the side of the second conducting layer. The dotted lines represent the continuation of divisions between conducting and insulating regions of the layer in which conductor 33 is formed beneath the second conducting layer. Signal portion 31 and shield portion 32 of the second conducting layer are shown. In the conductor layer, the conductor 33 is separated from conducting shielding within that layer by insulating material 35. The conductor 33 may be made of copper.

The purpose of the conducting layers is to electrically shield the conductor 33. This is the same principle as in a coaxial cable. However, in this case, the conducting layers only approximate a complete shield around the conductor 33. Optionally one or more of the conducting layers are connected to electrical ground.

The planar electrical connector 25 may be formed as a printed circuit board. Optionally, the conductor 33 of the planar connector 25 is electrically connected to the signal portion 31 of the second conducting layer by a via. In this case, the elongate conductor 24 may be inserted into the via. Another via may connect the shield portion 32 of the second conducting layer to the first conducting layer.

Optionally, the elongate conductor 24 is not a bare conductor, but has an insulator that surrounds and electrically isolates the elongate conductor 24 from the conducting surface of the front plate 22. For example, the elongate conductor 24 may be an inner conductor of a coaxial cable, as depicted in FIG. 2. In this case, the outer conductor 27 of the coaxial cable may be electrically connected to the conducting surface of the front plate 22. This provides a continuous electrical shield around the elongate conductor 24.

The invention is not limited to connecting a single elongate conductor 24 to a single conductor 33 of the flexible planar electrical connector 25. The flexible connector 25 may comprise a plurality of conductors 33 between the first insulating layer and the second insulating layer. In this case, the conductors 33 may be separated from each other by conducting shielding. For example, the conductors 33 may be formed from a single layer of copper, with the conductors 33 and intermediate shielding portions 35 formed by an etching operation. Insulating material isolates the intermediate shielding portions 35 from the conductors 33.

Furthermore, there may be a plurality of elongate conductors 24 that each extend through the front plate 22 and are each electrically connected to the flexible planar electrical connector 25. In this case, there would need to be a corresponding plurality of holes 28 in the front plate 22. With such a construction, a plurality of elongate conductors 24 may be connected to a corresponding plurality of conductors 33 within the flexible planar electrical connector 25.

The invention makes it possible to safely connect a flexible connector to a flex without the need for any potting material. That is, other than any insulating material that is integral to the cable containing the elongate conductor 24 and any insulating material integral to the flexible connector 25, there is no insulating material in the electrical connection system 21.

In an embodiment solid isolation is used to prevent electrical breakdown between parts of the electrical connection system 21. Solid isolation may prevent voltage breakdown between the elongate conductor 24 and the front plate 22, or between the signal portion 31 of the planar connector 25 and the shield portion 32 of the planar connector 25, for example.

The spaces between the components of the electrical connection system 21 mentioned above may be filled by an insulator. This process is termed potting. Desirably, the material used for the potting is an epoxy. The potting material may be optically transparent.

An advantage of potting the spaces within the electrical connection system 21 is that the electrical breakdown threshold of the system is less dependent on the ambient pressure. The electrical connection system 21 can be used at a great variety of different pressures, which may be different vacuum pressures.

The following is a description of a method of producing an electrical connection system 21 in which potting is employed. The front plate 22 may be attached to the planar connector 25. In an embodiment, the front plate is glued to the planar connector 25. The glue may be cured at an appropriate temperature, for example 40° C.

The elongate conductor 24 may be part of an insulated wire, or a coaxial cable, for example. The wire or cable is stripped and etched. The front plate 22 may be coated with potting material, for example an optically transparent epoxy.

A terminus of the elongate conductor 24 is attached to the conductor 33 of the planar connector. The electrical connection may be made via the signal portion 31 of the planar connector 25. The electrical connection may be made via soldering.

The space between the elongate conductor 24 and the front plate 22 is potted.

Desirably, the potting material fills a space between the signal portion 31 and the shield portion 32 of the planar connector 25. The potting material may be allowed to cure at a suitable temperature, for example 40° C. The curing step may take several hours.

The back plate 23 is attached to the opposite side of the planar connector 25, thereby sandwiching the planar connector 25 between the front plate 22 and the back plate 23. A second potting step may take place to fill a space between the back plate 23 and the elongate conductor 24. A further curing step may be necessary.

Once assembled, the electrical connection system 21 may be tested to ensure that it works without electrical breakdown and/or to determine whether the electrical connection system 21 satisfies any outgassing requirements. The materials selected are chosen to reduce the outgassing. However, it may not be possible to eliminate the outgassing completely. Accordingly, an electrical connection system 21 that reduces the outgassing is desirable.

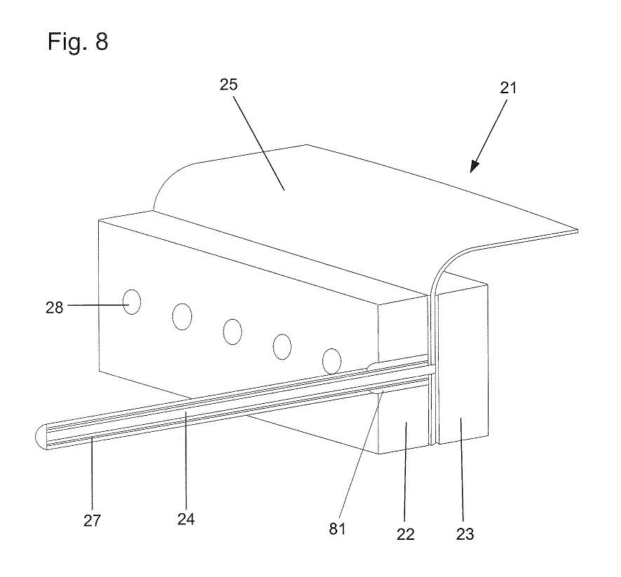

FIG. 8 depicts an embodiment in which a bushing 81 is used instead of potting material to provide electrical insulation to the electrical connection system 21. An advantage of using a bushing 81 instead of potting is that the potting and etching steps mentioned above in the method for manufacture are not necessary. This results in a simple manufacturing process and makes it easier to fix a problem with an electrical connection system 21 when there is a failure. If a bushing 81 is used, it is possible to manufacture an electrical connection system 21 using only simple mechanical actions such as screwing, crimping, etc.

Desirably, the bushing 81 electrically insulates the elongate conductor 24 from the conducting surface of the front plate 22. The electrical insulation property of the bushing 81 is independent of the ambient pressure of the electrical connection system 21. Therefore, there is no problem caused by the varying pressure in which the lithographic apparatus is used. Desirably, the bushing 81 electrically insulates the signal portion 31 of the planar connector 25 from the shield portion 32 of the planar connector 25. The bushing 81 may fill substantially all of the space within the electrical connection system 21. The bushing 81 surrounds a portion of the elongate conductor 24.

The bushing may be attached to a terminus of the elongate conductor 21. The bushing 81 may fill the whole of the region between the elongate conductor 24 and the facing conducting surface of the front plate 22 such that there are no gaps in which electrical breakdown may take place.

The bushing 81 may be a unitary component. This is different from potting the space surrounding the elongate conductor 24 with potting material in which case the potting material does not form a unitary component, but is instead formed from potting material after the elongate conductor 24 has been electrically connected to the conductor 33 of the planar connector 25. The bushing may be made of a fluropolymer elastomer. In an embodiment, the bushing is a Viton® bushing. Other types of material may also be used for the bushing. The bushing has the property that it provides electrical insulation.

Use of the bushing 81 has the advantage that the outgassing of the electrical connection system 21 is reduced compared to an electrical connection system 21 in which potting is used to provide electrical insulation. The electrical connection system 21 that uses a bushing 81 is quick to produce and may be less expensive to produce due to the reduction in process steps (e.g., absence of potting and etching steps) compared to the electrical connection system 21 that involves potting.

The electrical connection system 21 involving the bushing 81 may be manufactured as follows. The bushing 81 is attached to a terminus of the elongate conductor 24. Prior to this attachment, the elongate conductor 24 may have to be stripped if it is comprised as part of a coaxial cable or insulated wire, for example. The bushing 81 may be crimped onto the terminus of the elongate conductor 24.

The terminus with the attached bushing 81 is inserted into a hole 28 that extends through the front plate 22. The bushing 81 electrically insulates the elongate conductor 24 from the conducting surface of the front plate 22.

The terminus of the elongate conductor 24 is electrically connected to the conductor of the planar connector 25. The electrical connection may be made by soldering, for example.

The process may then involve sandwiching the planar connector 25 between the front plate 22 and the back plate 23.

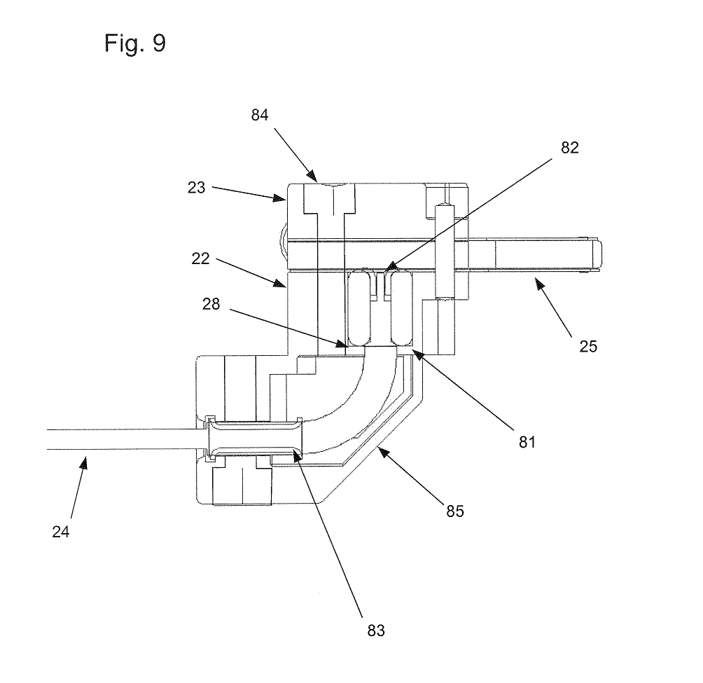

FIG. 9 depicts an embodiment in which at least one bushing 81 is used to provide electrical insulation within the electrical connection system 21. The bushing is a solid insulator. The bushing 81 may be compressible. In use, the bushing 81 is disposed in a compressed state. The bushing 81 is disposed in the hole 28. Desirably, a diameter of the bushing 81 is greater than a diameter of the hole 28. The purpose of this arrangement is to ensure that the bushing 81 is in a compressed state when it is inserted into the hole 28. This ensures a secure fitting of the bushing 81. In another embodiment, the bushing 81 is not compressible.

An end of the bushing 81 may have a tapered shape. As depicted in FIG. 9, the bushing 81 may have a contact trumpet 82 at an end of the bushing 81. The contact trumpet 82 is in contact with the planar connector 25. Desirably, the contact trumpet 82 electrically isolates the shield portion 32 of the planar connector 25 from the conductor portion 31 of the planar connector 25.

As depicted in FIG. 9, the electrical connection system may comprise a second housing 85. The elongate conductor 24 extends through the second housing 85. Desirably, the elongate conductor 24 bends a right angle within the second housing 85. The second housing 85 has an electrically conductive surface. A second bushing 83 may be disposed within the second housing 85. The second bushing 83 may be disposed around a portion of the elongate conductor 24. The second bushing 83 be disposed in a compressed state. The second bushing 83 may be crimped. The purpose of the second bushing is to provide strain relief to the elongate conductor, and to electrically shield the elongate conductor 24 from the second housing 85.

The electrical connection system 21 may be provided with a squeeze mechanism 84. The squeeze mechanism 84 provides a pressing force pressing the front plate 22 and the back plate 23 together. The second housing 85 may be provided with a squeeze mechanism.

The electrical connection system 21 may be used to electrically connect an elongate conductor 24 (e.g., part of a coaxial cable or insulated wire, for example) to a section of a planar connector 25 (e.g., a flexible printed circuit board). The planar connector 25 of the electrical connection system 21 may be connected to a further section of flexible printed circuit board. Such flexible printed circuit board may be used as wiring in a lithographic apparatus. The other end of the flexible printed circuit board used as wiring may be connected to a printed circuit assembly.

Alternatively, the electrical connection system 21 may be used to directly electrically connect an elongate conductor 24 to a printed circuit assembly, in which case the planar connector 25 of the electrical connection system 21 is the printed circuit assembly itself. This arrangement has the advantage that it avoids the requirement of two connections between flexible planar connectors.

The electrical connection system 21 of the present invention is optionally included in a lithographic apparatus. Optionally, the lithographic apparatus according to an embodiment of the invention comprises a controller for controlling a display means to displaying a signal that the situation is safe when the pressure is below a threshold value, for example 10 Pa. A pressure sensor detects the pressure within the vacuum vessel. When the pressure sensor detects that the pressure has increased above the threshold value, the controller stops the signal from being displayed. Optionally, the controller prevents the pressure inside the vacuum vessel from increasing above a predetermined value, for example 20 Pa, when there is an unintended leak.

Optionally, the lithographic apparatus comprises a safety cut out system. The controller sends a signal to switch off the power supply when the pressure increases above a particular pressure. For example, a pressure sensor detects the pressure. When it is detected that the pressure is greater than 20 Pa, for example, the controller sends a switch-off signal to the power supply unit.

The above described embodiments of electrical connectors and electrical connection systems 21 of the present invention are suitable for use in a lithographic apparatus to connect an actuator of either a mask table or a substrate table to a power supply 20. Additionally, embodiments of the present invention may be used to connect the actuator or controller of any beam interceptor 210 (such as a blade) or the electrodes of any electrostatic clamp that may form part of a lithographic apparatus. However, the electrical connector and electrical connection system according to embodiments of the present invention is not limited to use as part of a lithographic apparatus. The electrical connector and electrical connection system is applicable in other situations where it is desired to connect electrical lines that carry high voltages in low pressure environments.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography, topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g., having a wavelength of or about 365, 355, 248, 193, 157 or 126 nm) and extreme ultra-violet (EUV) radiation (e.g., having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g., semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. An electrical connection system comprising:
a housing comprising a front plate having a conducting surface;
an elongate conductor extending through the front plate;
a flexible planar electrical connector comprising a conductor; and
a bushing electrically insulating the elongate conductor from the conducting surface of the front plate;
wherein the elongate conductor is electrically connected to the conductor of the planar electrical connector.

2. The electrical connection system according to claim 1, wherein the elongate conductor is connected to the conductor of the planar electrical connector at a terminus of the elongate conductor.

3. The electrical connection system according to claim 1, wherein the bushing is a unitary component.

4. The electrical connection system according to claim 3, wherein the bushing is made of a fluoropolymer elastomer.

5. The electrical connection system according to claim 1, wherein the housing further comprises a back plate having a conducting surface, wherein the flexible planar electrical connector is sandwiched by and extends beyond the front plate and the back plate.

6. The electrical connection system according to claim 1, wherein the planar electrical connector comprises a laminate that comprises, in order, the following layers:
a first flexible planar insulating layer;
the conductor configured to carry an electrical current; and
a second flexible planar insulating layer.

7. An electrical connection system comprising:
a housing comprising a front plate having a conducting surface and a back plate having a conducting surface;
an elongate conductor extending through the front plate; and
a flexible planar electrical connector comprising a laminate that comprises, in order, the following layers:
a first flexible planar insulating layer;
a conductor configured to carry an electrical current; and
a second flexible planar insulating layer;
wherein the flexible planar electrical connector is sandwiched by and extends beyond the front plate and the back plate; and
the elongate conductor is electrically connected to the conductor of the planar electrical connector.

8. The electrical connection system according to claim 7, further comprising a bushing electrically insulating the elongate conductor from the conducting surface of the front plate.

9. The electrical connection system according to claim 8, wherein the bushing occupies substantially a whole region between the elongate conductor and the front plate.

10. The electrical connection system according to claim 1, wherein the bushing occupies substantially a whole region between the elongate conductor and the front plate.

11. The electrical connection system according to claim 9, wherein the conductor of the planar electrical connector and the insulating layers are sandwiched by a first planar conducting layer and a second planar conducting layer that comprises:
a conductor portion electrically connected to the conductor of the planar electrical connector; and
a shield portion that surrounds and is electrically isolated from the conductor portion;
wherein the elongate conductor is electrically connected to the conductor portion.

12. The electrical connection system according to claim 10, wherein the conductor of the planar electrical connector and the insulating layers are sandwiched by a first planar conducting layer and a second planar conducting layer that comprises:
a conductor portion electrically connected to the conductor of the planar electrical connector; and
a shield portion that surrounds and is electrically isolated from the conductor portion;
wherein the elongate conductor is electrically connected to the conductor portion.

13. The electrical connection system according to claim 11, wherein the elongate conductor is an inner conductor of a coaxial cable, and wherein an outer conductor of the coaxial cable is electrically connected to the conducting surface of the front plate.

14. The electrical connection system according to claim 12, wherein the elongate conductor is an inner conductor of a coaxial cable, and wherein an outer conductor of the coaxial cable is electrically connected to the conducting surface of the front plate.

15. The electrical connection system according to claim 7, wherein the flexible planar electrical connector comprises a plurality of conductors between the first flexible planar insulating layer and the second flexible planar insulating layer, and wherein the flexible planar electrical connector comprises a plurality of elongate conductors that each extend through the front plate and are electrically connected to a corresponding conductor of the flexible planar electrical connector.

16. The electrical connection system according to claim 7, wherein at least one of the front plate and the back plate has a thickness greater than or equal to about 5 mm and/or less than or equal to about 10 mm.

17. A lithographic apparatus comprising:
a substrate table for holding a substrate;
an electrostatic chuck for holding said substrate to said substrate table, said electrostatic chuck comprising a planar member made of a dielectric material and being a separate body to said substrate table;
first and second clamp electrodes, said first clamp electrode being provided on said substrate table and said second clamp electrode being provided as a conductive layer on said substrate; and
a power supply for applying a potential difference between said first and second clamp electrodes so that when said electrostatic chuck is placed on a surface of said substrate table and said substrate is placed on said electrostatic chuck, electrostatic clamping forces are generated between said substrate table and said electrostatic chuck and between said electrostatic chuck and said substrate;
wherein at least one of the first electrode and the second electrode is connected to the power supply using an electrical connection system comprising:
a housing comprising a front plate having a conducting surface;
an elongate conductor extending through the front plate;
a flexible planar electrical connector comprising a conductor; and
a bushing electrically insulating the elongate conductor from the conducting surface of the front plate;
wherein the elongate conductor is electrically connected to the conductor of the planar electrical connector.

18. A method for manufacturing an electrical connection system configured to connect an elongate conductor to a flexible planar electrical connector, the method comprising the steps of:
attaching a bushing to a terminus of the elongate conductor;
inserting the terminus with the attached bushing into a hole that extends through a front plate having a conducting surface such that the bushing electrically insulates the elongate conductor from the a conducting surface of the front plate; and
electrically connecting the terminus to a conductor comprised in the planar electrical connector.

19. The method of claim 18, further comprising sandwiching the planar connector between the front plate and a back plate having a conducting surface such that the planar connector extends beyond the front plate and the back plate.
